(19) United States
(12) Patent Application Publication
(10) Pub. No.: US 2022/0190673 A1
(43) Pub. Date: Jun. 16, 2022

(54) HEAT TRANSFER ARRAY AND THE ELECTRIC MACHINE MADE THEREWITH

(71) Applicant: Moog Inc., East Aurora, NY (US)

(72) Inventor: Ping P. Zhong, Amherst, NY (US)

(21) Appl. No.: 17/604,184

(22) PCT Filed: Apr. 17, 2020
(86) PCT No.: PCT/US2020/028743

§ 371 Date: Oct. 15, 2021

Related U.S. Application Data
(60) Provisional application No. 62/835,020, filed on Apr. 17, 2019.

(51) Int. Cl. H02K 5/18; H02K 9/18

(52) U.S. Cl. CPC H02K 5/18; H02K 9/18

(57) ABSTRACT

An electric machine including a housing defining a longitudinal axis. A first plurality of fins coupled with an outer surface of the housing, wherein the first plurality of fins is positioned parallel with the longitudinal axis. A second plurality of fins coupled with the outer surface positioned transverse to the longitudinal axis, wherein at least a portion of the second plurality of fins is located axially adjacent to the first plurality of fins. A third plurality of fins coupled with the outer surface, wherein at least a portion of the third plurality of fins is located axially adjacent to the second plurality of fins and beside the first plurality of fins, wherein the third plurality of fins are positioned transverse to the longitudinal axis. A fourth plurality of fins coupled with the outer surface, wherein at least a portion of the fourth plurality of fins is located axially adjacent to the third plurality of fins and beside the second plurality of fins, wherein the fourth plurality of fins are positioned parallel to the longitudinal axis. A first fan assembly is located above at least a portion of the first and second pluralities of fins, and a second fan assembly is located above at least a portion of the third and fourth pluralities of fins.

### TECHNICAL FIELD

The present disclosure relates generally to electric machines and more specifically to the dissipation of heat in fan cooled electric motors.

### BACKGROUND

Electric machines such as motors and generators are widely utilized in industrial applications to drive machinery. Electrical current produces heat via resistive heating and inductive heating during the operation of electric machines. Additionally, friction within the electric machine may produce heat. The heat produced during operation of the electric machine decreases the performance and life of the electric machine.

Electric machines often include structures mounted to the outer surface thereof. These structures have traditionally blocked airflow utilized to dissipate heat generated by the electric machine, creating areas of high turbulent flow, decreasing airflow pressure and increasing noise.

The electric machine described herein provides superior heat transfer characteristics and performance.

### SUMMARY

The present disclosure provides for an electric machine. In a first exemplary embodiment, an electric machine includes a housing (102) defining a longitudinal axis (106). A first plurality of fins (110) are coupled with an outer surface (102A) of the housing, wherein the first plurality of fins is positioned parallel to the longitudinal axis. A second plurality of fins (112) are coupled with the outer surface of the housing axially adjacent to the first plurality of fins, wherein the second plurality of fins are positioned transverse to the longitudinal axis. A third plurality of fins (114) are coupled with the outer surface of the housing beside the second plurality of fins, wherein the third plurality of fins are positioned transverse to the longitudinal axis. A fourth plurality of fins (116) are coupled with the outer surface of the housing axially adjacent to the third plurality of fins and beside the first plurality of fins, wherein the fourth plurality of fins are positioned transverse to the longitudinal axis. A fifth plurality of fins (118) are coupled with the outer surface of the beside the fourth plurality of fins opposite to the first plurality of fins, wherein the fifth plurality of fins are positioned transverse to the longitudinal axis. A sixth plurality of fins (120) are coupled with the outer surface of the housing axially adjacent to the fifth plurality of fins and beside the third plurality of fins, wherein the sixth plurality of fins are positioned parallel to the longitudinal axis. The electric machine further includes a first fan assembly (130) located above the first and second pluralities of fins, and a second fan assembly (130) located above the fifth and sixth pluralities of fins.

In a second exemplary embodiment, an electric machine includes a housing (102) having a generally cylindrical geometry, wherein the housing defines a longitudinal axis (106). A first plurality of fins (110) coupled with a radially outer surface (102A) of the housing, wherein the first plurality of fins are positioned parallel to the longitudinal axis. A second plurality of fins (113) coupled with the radially outer surface of the housing positioned transverse to the longitudinal axis, wherein at least a portion of the second plurality of fins is located axially adjacent to the first plurality of fins. A third plurality of fins (117) coupled with the radially outer surface of the housing, wherein at least a portion of the third plurality of fins is located axially adjacent to the second plurality of fins and circumferentially adjacent to the first plurality of fins, wherein the third plurality of fins are positioned transverse to the longitudinal axis. A fourth plurality of fins (120) coupled with the radially outer surface of the housing, wherein at least a portion of the fourth plurality of fins is located axially adjacent to the third plurality of fins and circumferentially adjacent to the second plurality of fins, wherein the fourth plurality of fins are positioned parallel to the longitudinal axis. The electric machine further includes a first fan assembly (130) located above at least a portion of the first and second pluralities of fins, and a second fan assembly (130) located above at least a portion of the third and fourth pluralities of fins.

### BRIEF DESCRIPTION OF THE SEVERAL VIEWS OF THE DRAWINGS

The accompanying drawings are incorporated herein as part of the specification. The drawings described herein illustrate embodiments of the presently disclosed subject matter and are illustrative of selected principles and teachings of the present disclosure. However, the drawings do not illustrate all possible implementations of the presently disclosed subject matter and are not intended to limit the scope of the present disclosure in any way.

FIG. 1 is a perspective view of an electric machine according to an embodiment of the present disclosure.

FIG. 2 is a perspective view of the electric machine according to the embodiment illustrated in FIG. 1.

FIG. 3 is a sectional view taken along line 3-3 of FIG. 2.

FIG. 4 is a side view of a portion of the electric machine according to the embodiment illustrated in FIG. 1.

FIG. 5 is a top view of a portion of the electric machine according to the embodiment illustrated in FIG. 1.

FIG. 6 is a top view of a portion of the electric machine according to the embodiment illustrated in FIG. 1.

FIG. 7 is a side view of a portion of the electric machine according to the embodiment illustrated in FIG. 1.

FIG. 8 is a perspective view of a portion of an electric machine according to the embodiment illustrated in FIG. 1.

FIG. 9 is a perspective view of a portion of an electric machine according to an embodiment of the present disclosure.

### DETAILED DESCRIPTION

It is to be understood that the invention may assume various alternative orientations and step sequences, except where expressly specified to the contrary. It is also to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application. As used in the following specification, terms of orientation such as “horizontal,” “vertical,” “left,” “right,” “up,” and “down,” as well as adjectival and adverbial derivatives thereof, (e.g., “horizontally,” “rightwardly,” “upwardly,” etc.), simply refer to the orientation of the illustrated structure as the particular drawing figure faces the reader. Similarly, the terms “inwardly” and “outwardly” generally refer to the orientation of a surface relative to its axis of elongation, or of rotation, as appropriate.

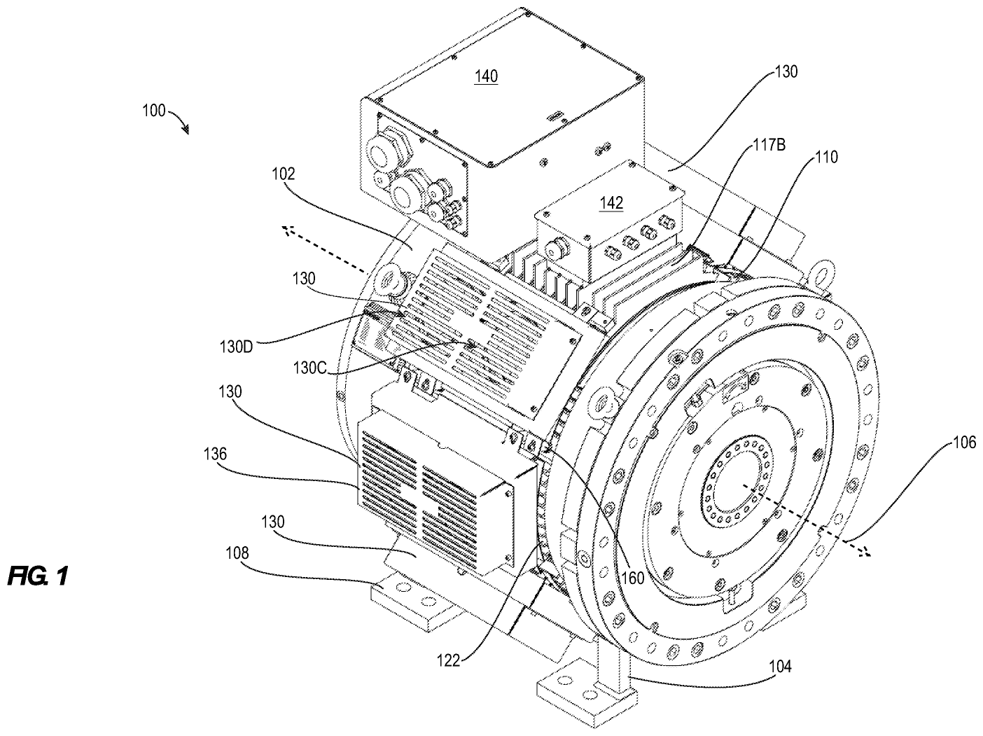

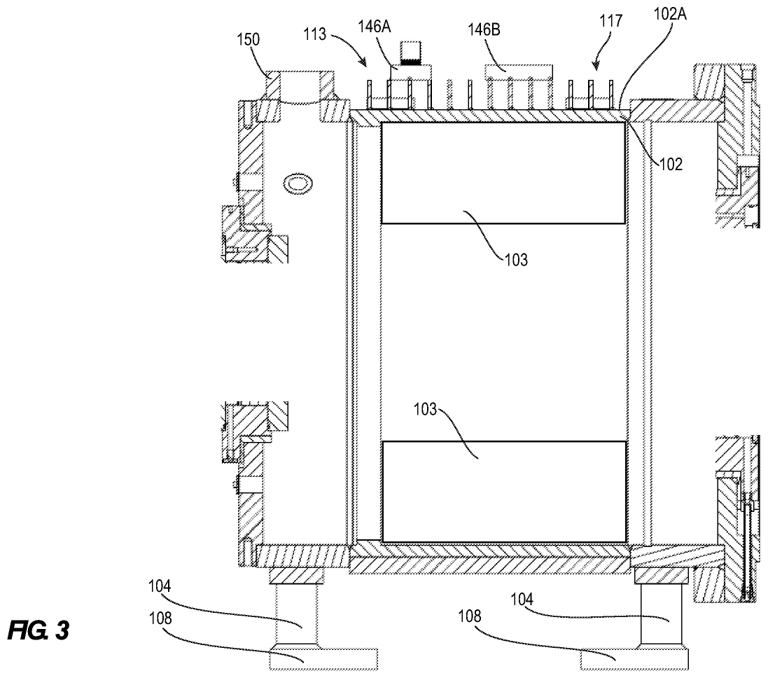

As illustrated in FIG. 1, in an embodiment, an electric machine 100 comprises a totally enclosed fan cooled (“TEFC”) electric motor/generator. The electric machine 100 includes a housing 102 disposed about a stator 103 (see FIG. 3). In an embodiment, the housing 102 may be located radially adjacent to the stator 103 such that the housing 102 and the stator 103 are in direct contact. In another embodiment, a thermally conductive material may be located between the housing 102 and the stator 103. In an embodiment, the stator 103 comprises a laminated core.

The housing 102 defines a generally cylindrical geometry and a longitudinal axis 106. The housing 102 also defines an outer circumference having the longitudinal axis 106 as the center point thereof. As illustrated in FIGS. 1-3, in an embodiment, the housing 102 provides a sealed interior to militate against the circulation of air, water, and debris within the housing 102. Mounting feet 108 are coupled with the housing 102. In an embodiment, the electric machine 100 includes four mounting feet 108. The mounting feet 108 are coupled with the housing 102 via legs 104. Together, the mounting feet 108 and the associated legs 104 form a stand.

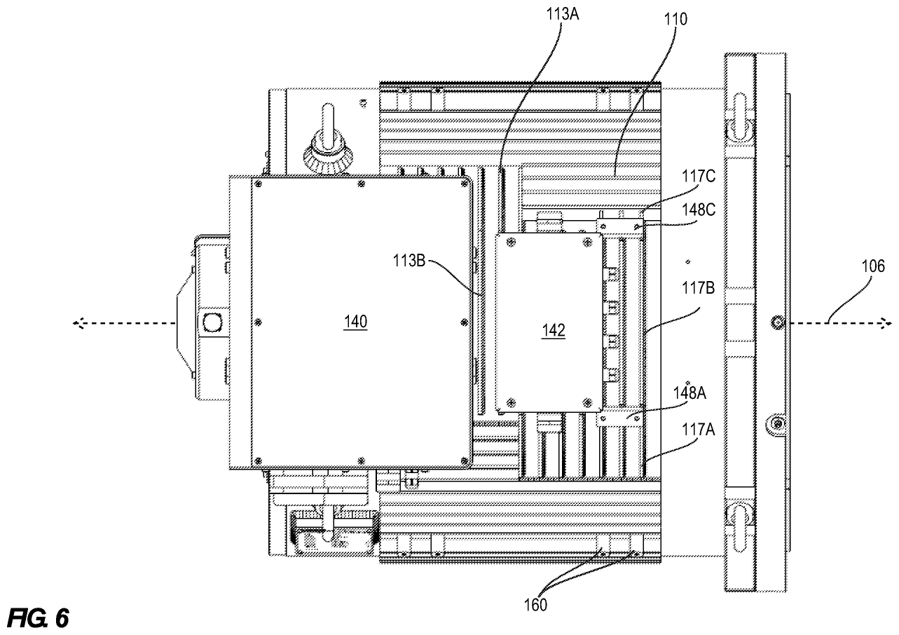

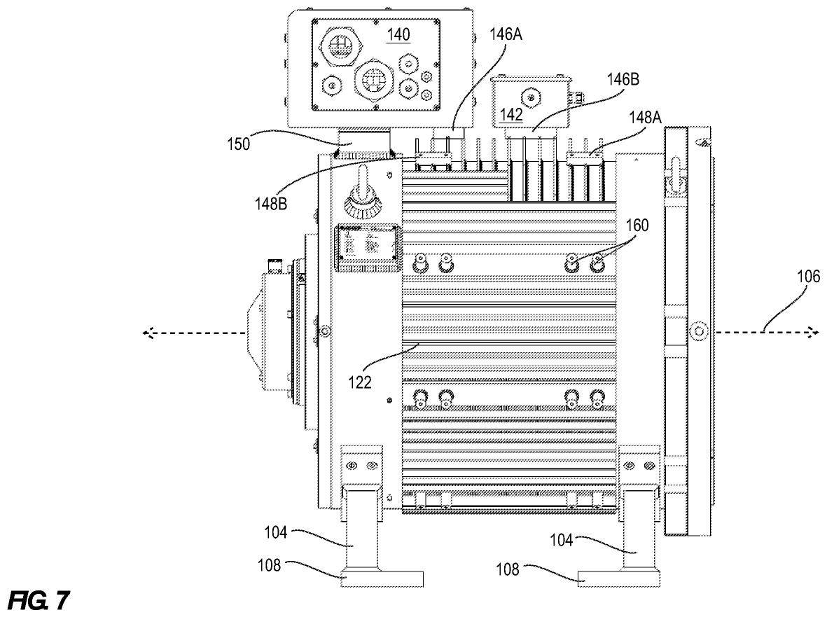

As illustrated in FIGS. 1-7, the electric machine 100 includes a first set of fins 110 coupled with the radially outer surface 102A of the housing 102. The term “fins” may be utilized interchangeably with the term “extended surfaces” herein. The first set of fins 110 is oriented generally parallel with the longitudinal axis 106 of the electric machine 100. In other words, the first set of fins 110 extends axially on the housing radially outer surface 102A and projects radially outward therefrom. In an embodiment, the first set of fins 110 are welded to the housing 102. The first set of fins 110 comprise a first height.

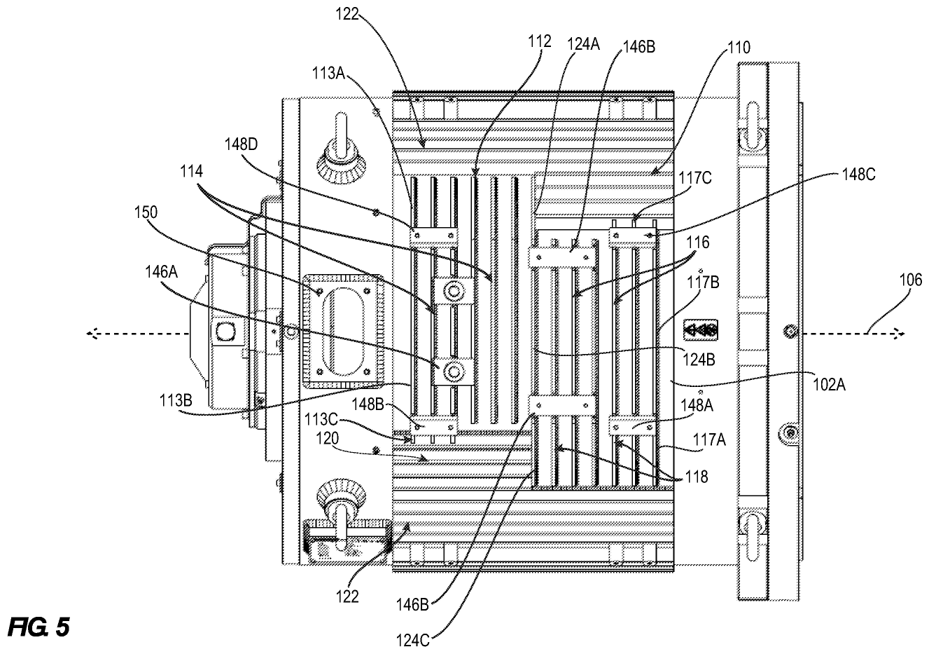

Referring now to FIG. 5, a second set of fins 112 is coupled with the radially outer surface 102A of the electric machine housing 102. The second set of fins 112 is located axially adjacent to the first set of fins 110. The second set of fins 112 is oriented transverse and/or generally perpendicular to the orientation of the first set of fins 110 such that the second set of fins 112 is disposed in a series of planes generally perpendicular to the longitudinal axis 106. In an embodiment, the second set of fins 112 comprise a height generally equal to the height of the first set of fins 110.

A third set of fins 114 is coupled with the radially outer surface 102A of the electric machine housing 102. The third set of fins 114 is located circumferentially adjacent to the second set of fins 112. The third set of fins 114 is oriented generally parallel with the second set of fins 112 such that they are disposed generally perpendicular to the electric machine longitudinal axis 106. In an embodiment, the fins of the third set of fins 114 may be aligned with the fins of the second set of fins 112, respectively. In another embodiment, the fins of the third set of fins 114 may be arranged axially offset from the fins of the second set of fins 112. The third set of fins 112 may comprise a height greater than the height of the first set of fins 110.

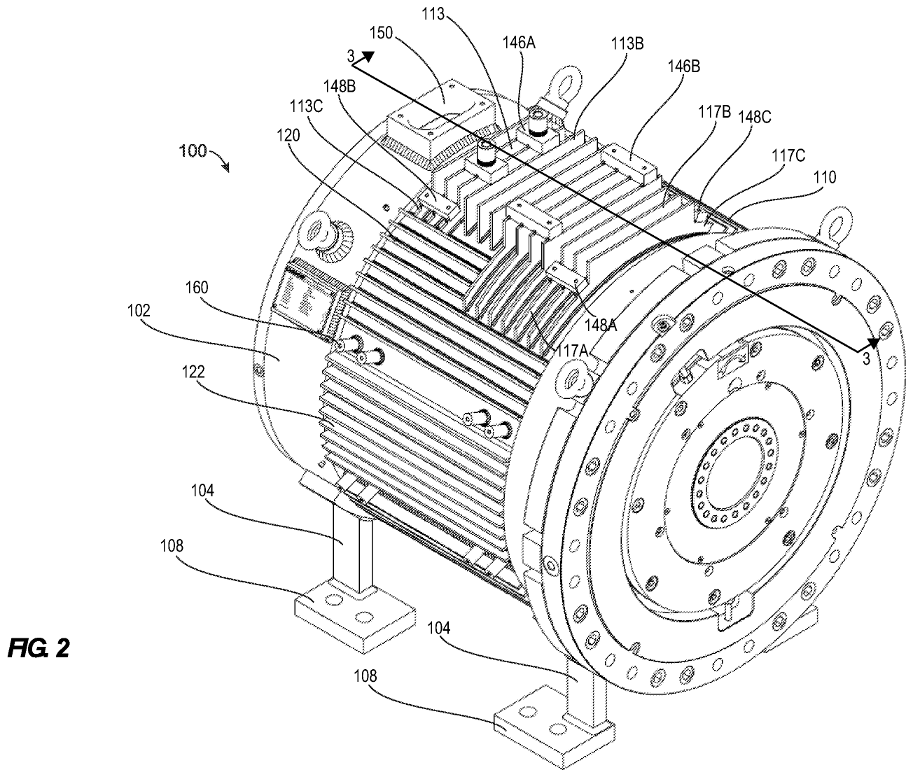

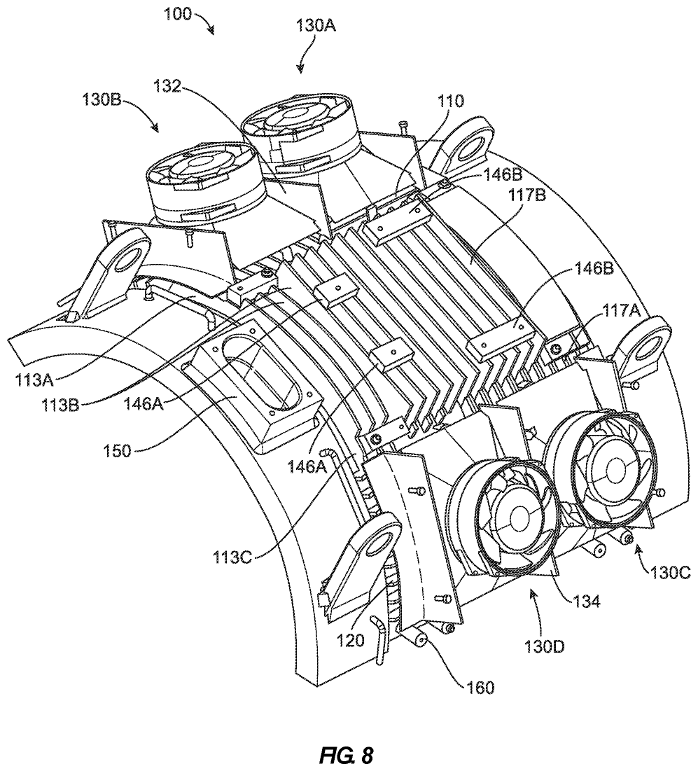

As illustrated in FIGS. 2 and 5-6, in an embodiment, the second set of fins 112 and the third set of fins 114 may be formed from a first set of transverse fins 113. Each fin in the first set of transverse fins 113 defines a first portion 113A having a first height and a second portion 113B having a second height. The second height of each transverse fin 113 is greater than the first height thereof, wherein the first height of the first set of transverse fins 113 is generally equal to the height of the first set of fins 110. The first portion 113A defines an arcuate radially outer edge for at least a portion of the length of each fin 113. The second portion 113B defines a straight radially outer edge for at least a portion of the length of each fin 113. In an embodiment, as illustrated in FIG. 8, one or more of the fins in the first set of transvers fins 113 includes a second portion 113B defining an arcuate radially outer edge.

The first portion 113A of each fin of the first set of transverse fins 113 may define a length shorter than the length of the second portion 113B. Additionally, each fin of the first set of transverse fins 113 may define a third portion 113C located adjacent to the second portion 113B opposite to the first portion 113A. The third portion 113C may have a height equal to the height of the first portion 113A. Further, the third portion 113C may define a length shorter than the first portion 113A. In an embodiment, the number of fins in the first transverse set of fins 113 including the third portion 113C is less than the total number of fins in the first transverse set of fins 113. For example, the first set of transverse fins 113 may comprise six fins, and three adjacent fins at the axially outer end of the first set of transverse fins 113 may include the third portion 113C.

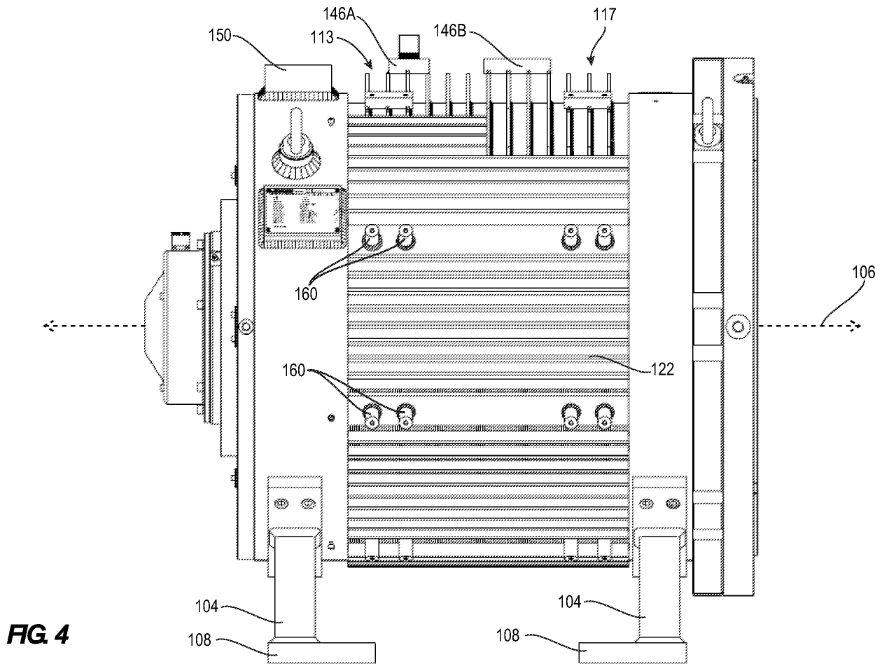

Referring now to FIGS. 4-6, a fourth set of fins 116 is also coupled with the housing radially outer surface 102A. The fourth set of fins 116 is located circumferentially adjacent to the first set of fins 110 and axially adjacent to the third set of fins 114. The fourth set of fins 116 is oriented generally parallel with the third set of fins 114 such that it is disposed generally perpendicular with the electric machine longitudinal axis 106. The fourth set of fins 116 comprise a height greater than the height of the first set of fins 110 and a height generally equal to the height of the third set of fins 114.

A fifth set of fins 118 is coupled with the housing radially outer surface 102A circumferentially adjacent to the fourth set of fins 116 opposite the first set of fins 110. The fifth set of fins 118 is oriented generally parallel with the third and fourth sets of fins 114, 116 such that they are disposed generally perpendicular to the electric machine longitudinal axis 106. In an embodiment, the fins of the fifth set of fins 118 may be aligned with the fins of the fourth set of fins 116, respectively. In another embodiment, the fins of the fifth set of fins 118 may be arranged axially offset from the fins of the fourth set of fins 116.

As illustrated in FIG. 2, in an embodiment, the fourth set of fins 116 and the fifth set of fins 118 may be formed from a second set of transverse fins 117. Each fin in the second set of transverse fins 117 defines a first portion 117A having a first height and a second portion 117B having a second height. The second height of each transverse fin second portion 117B is greater than the first height thereof, wherein the first height of the second set of transverse fins 117 is generally equal to the height of the first set of fins 110 and the second height is generally equal to the height of the first set of transverse fins second portion 113B. The first portion 117A defines an arcuate radially outer edge for at least a portion of the length of each fin and the second portion 117B defines a straight radially outer edge for at least a portion of the length of each fin. The first portion 117A may define a length shorter than the length of the second portion 117B. Additionally, each fin of the second set of transverse fins 117 may define a third portion 117C located adjacent to the second portion 117B opposite to the first portion 117A. The third portion 117C may have a height equal to the height of the first portion 117A. Further, the third portion 117C may define a length shorter than the first portion 117A. In an embodiment, the number of fins in the second transverse set of fins 117 including the third portion 117C is less than the total number of fins. For example, the second set of transverse fins 117 may comprise six fins, and three adjacent fins at the axially outer end of the second set of transverse fins 117 include the third portion 117C.

As illustrated in FIG. 5, in an embodiment, an extended fin 124 is coupled with the radially outer surface 102A of the electric machine housing 102. The extended fin 124 is located axially between the first set of transverse fins 113 (and/or the third set of fins 114) and the second set of transverse fins 117 (and/or the fourth set of fins 116). The extended fin 124 defines a first portion 124A in-line with the first portion 113A of the first set of transverse fins 113, a second portion 124B in-line with the second portion 113B, 117B of the first and second sets of transverse fins 113, 117, and a third portion 124C in-line with the first portion 117A of the second set of transverse fins 117. The first portion 124A comprises a height generally equal to the height of the first portion 113B, the second portion 124B comprises a height generally equal to the height of the second portions 113B, 117B, and the third portion 124C comprises a height generally equal to the height of the first portion 117A.

Referring now to FIGS. 2, 5, and 8, a sixth set of fins 120 may be coupled with the radially outer surface 102A of the electric machine housing 102. The sixth set of fins 120 is oriented generally parallel with the longitudinal axis 106 of the electric machine 100 and with the first set of fins 110. Additionally, the sixth set of fins 120 is located axially adjacent to the fifth set of fins 118 and/or the second set of transverse fins first portion 117A. Further, the sixth set of fins 120 is located circumferentially adjacent to the third set of fins 114 and/or the first set of transverse fins second portion 113B. The sixth set of fins 120 extends axially on the housing radially outer surface 102A and projects radially outward therefrom. The sixth set of fins 120 comprises a height generally equal to the height of the first set of fins 110.

In an embodiment, a seventh set of fins 122 may be located about the housing radially outer surface 102A. The seventh set of fins 122 are oriented generally parallel with the electric machine longitudinal axis 106. Further, the seventh set of fins 122 comprise a height generally equal to the height of the first set of fins 110. The seventh set of fins 122 are characterized, at least in part, by their length, which is approximately twice the length of the first and sixth set of fins 110, 120. The fins 110, 112, 113 114, 116, 117, 118, 120, 122 project radially outward from the housing radially outer surface 102A. The fins 110, 112, 113 114, 116, 117, 118, 120, 122 increase the surface area of the electric machine housing 102 and the heat transfer rate thereof. Additionally, in an embodiment, the fins 110, 112, 113 114, 116, 117, 118, 120, 122 are welded to the housing 102.

As illustrated in FIGS. 1 and 8, in an embodiment, a plurality of fan assemblies 130 may be coupled with the electric machine 100. The fan assemblies 130 may be utilized to increase fluid flow over the fins 110, 112, 113, 114, 116, 117, 118, 120, 122, 124 and thereby increase the convective heat transfer of the electric machine 100. In an embodiment, the fan assemblies 130 may be mounted about the housing radially outer surface 102A. The fan assemblies 130 comprise two radially mounted axial-flow fans located at least partially within a housing 136. The fans are oriented within the housing 136 of the fan assembly 130 in an alignment parallel with the electric machine housing longitudinal axis 106. As illustrated in FIG. 1, the fan assembly housing 136 includes apertures to facilitate fluid flow therethrough.

As illustrated in FIG. 8, the first fan 130A of a first fan assembly 130 is mounted over the first set of fins 110 such that the first fan 130A is disposed radially outward therefrom. The second fan 130B of the first fan assembly 130 is mounted over the first portion 113A of the first set of transverse fins 113 such that the second fan 130B is disposed radially outward therefrom. A third fan 130C of a second fan assembly 130 is mounted over the first portion 117A of the second set of transverse fins 117, and a fourth fan 130D of the second fan assembly 130 is mounted over the sixth set of fins 120.

As illustrated in FIGS. 1, 6 and 7, a terminal box 140 and an auxiliary terminal box 142 are coupled with the electric machine housing 102 radially outward of the second portion 113B of the first set of transverse fins 113 and the second portion 117B of the second set of transverse fins 117, respectively. Referring now to FIGS. 2-5 and 7, a first set of mounting plates 146A may be connected with the radially outer edge of one or more fins of the second portion 113B of the first set of transverse fins 113 for coupling the terminal box 140 with the electric machine 100. Similarly, a second set of mounting plates 146B may be connected with the radially outer edge of one or more fins of the second portion 117B of the second set of transverse fins 117 for coupling the auxiliary terminal box 142 with the electric machine 100. The first and second mounting plates 146A, 146B may be connected with the fins 113B, 117B via a method such as, but not limited to, welding. Additionally, the second mounting plates 146B may comprise a greater length than the first mounting plates 146A. In an embodiment, the electric machine 100 includes two first mounting plates 146A and two second mounting plates 146B.

Further, the electric machine 100 may include a third set of mounting plates 148 utilized to connect the first and second fan assemblies 130A, 130B, 130C, 130D with the electric machine housing 102. The third set of mounting plates 148 are connected with the radially outer edge of one or more fins of the first and second transverse sets of fins 113, 117. The mounting plate 148A may be connected with one or more first portions 117A of the second set of transverse fins 117, the mounting plate 148B may be connected with one or more third portions 113C of the first set of transverse fins 113, the mounting plate 148C may be connected with one or more third portions 117C of the second set of transverse fins 117, and the mounting plate 148D may be connected with one or more first portions 113A of the first set of transverse fins 113.

In addition, an electrical lead and/or connection opening 150 may be located through the electric machine housing 102 axially adjacent to the first set of transverse fins 113. In conjunction with the mounting plates 146A, the lead opening 150 may connect the terminal box 140 with the electric machine housing 102 and/or support the terminal box 140 thereon.

In an embodiment, as illustrated in FIG. 8, the first fan assembly 130 comprising fans 130A, 130B includes a first airflow separation plate 132 located axially between the first and second fans 130A, 130B to prevent and/or limit interference between the airflows produced thereby. The first airflow separation plate 132 is at least partially oriented in a plane perpendicular to the electric machine housing longitudinal axis 106. The second fan assembly 130 comprising fans 130C, 130D includes a second airflow separation plate 134 located axially between the third and fourth fans 130C, 130D to prevent and/or limit interference between the airflows produced thereby. The second airflow separation plate 134 is also at least partially oriented in a plane perpendicular to the electric machine housing longitudinal axis 106.

The fans 130A, 130B, 130C, 130D draw air radially inward, and produce, distribute and/or blow air over and between the first set of fins 110, the first transverse set of fins 113, the second transverse set of fins 117 and the sixth set of fins 120, respectively. Air drawn through the second fan 130B flows over and between the first portion 113A of the first set of transverse fins 113. The airflow travels between the fin first portions 113A to the second portion 113B of the first set of transverse fins 113. Air drawn through the third fan 130C flows over and between the second and fifth sets of fins 112, 118, respectively. The airflow travels between the first portion 117A of the second set of transverse fins 117. The airflow travels between the fin first portions 117A to the second portion 117B of the second set of transverse fins 117.

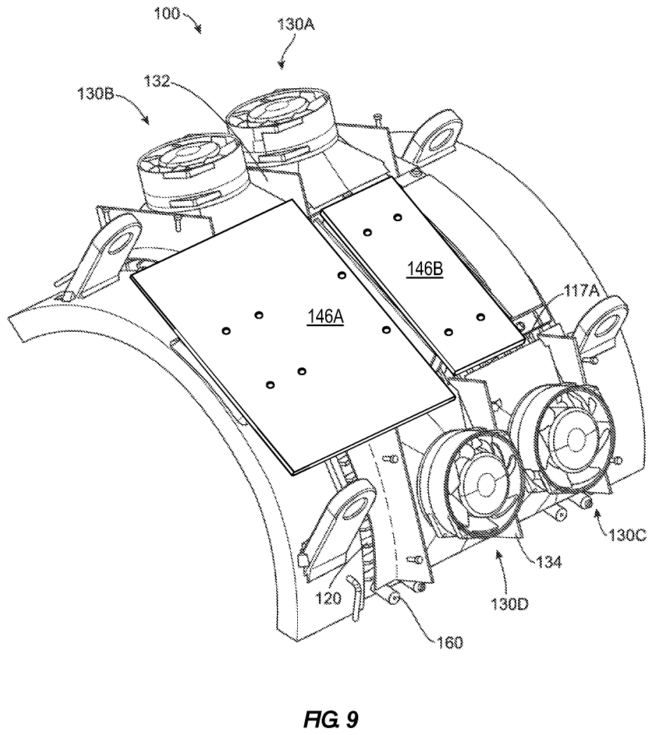

The position of the terminal box 140 and the auxiliary terminal box 142, and/or mounting plates 146A, 146B, radially over the first and second sets of transverse fins 113, 117 serves to increase the duration of time the airflow is retained between the fins 113, 117. As illustrated in FIG. 9, in an embodiment, the mounting plates 146A, 146B are formed as two plates located on the fins 113, 117. In this embodiment, the mounting plates 146A, 146B generally cover the fins 113, 117 and form a plurality of uniform airflow channels defined, at least in part, by the mounting plates 146A, 146B and the fins 113, 117. Retaining the airflow within the fins 113, 117 facilitates increased heat transfer between the fins 113, 117 and the airflow before the airflow transits outside of the fins 113, 117.

As illustrated in FIG. 1, additional fan assemblies 130 are mounted about the housing radially outer surface 102A over the seventh set of fins 122. These additional fan assemblies 130 may be connected with the electric machine house 102 via mounting studs 160.

One or more features of the embodiments described herein may be combined to create additional embodiments which are not depicted. While various embodiments have been described in detail above, it should be understood that they have been presented by way of example, and not limitation. It will be apparent to persons skilled in the relevant arts that the disclosed subject matter may be embodied in other specific forms, variations, and modifications without departing from the scope, spirit, or essential characteristics thereof. The embodiments described above are therefore to be considered in all respects as illustrative, and not restrictive. The scope of the invention is indicated by the appended claims, and all changes that come within the meaning and range of equivalents thereof are intended to be embraced therein.

What is claimed is:

1. An electric machine, comprising:
a housing defining a longitudinal axis;
a first plurality of fins coupled with an outer surface of said housing, wherein said first plurality of fins are positioned parallel to said longitudinal axis;
a second plurality of fins coupled with said outer surface of said housing axially adjacent to said first plurality of fins, wherein said second plurality of fins are positioned transverse to said longitudinal axis;
a third plurality of fins coupled with said outer surface of said housing beside said second plurality of fins, wherein said third plurality of fins are positioned transverse to said longitudinal axis;
a fourth plurality of fins coupled with said outer surface of said housing axially adjacent to said third plurality of fins and beside said first plurality of fins, wherein said fourth plurality of fins are positioned transverse to said longitudinal axis;
a fifth plurality of fins coupled with said outer surface of said beside said fourth plurality of fins opposite to said first plurality of fins, wherein said fifth plurality of fins are positioned transverse to said longitudinal axis;
a sixth plurality of fins coupled with said outer surface of said housing axially adjacent to said fifth plurality of fins and beside said third plurality of fins, wherein said sixth plurality of fins are positioned parallel to said longitudinal axis;
a first fan assembly located above said first and second pluralities of fins; and
a second fan assembly located above said fifth and sixth pluralities of fins.

2. The electric machine according to claim 1, wherein said first fan assembly comprises:
a first fan; and
a second fan positioned adjacent to said first fan, wherein said first fan is located over said first plurality of fins and said second fan is located over said second plurality of fins.

3. The electric machine according to claim 2, said first fan assembly further comprising:
a first plate located between said first and second fans, whereby said first plate mitigates airflow interference between said first and second fans.

4. The electric machine according to claim 2, wherein:
said first fan of said first fan assembly produces air flow between said first plurality of fins; and
said second fan of said first fan assembly produces air flow between said second plurality of fins and said third plurality of fins.

5. The electric machine according to claim 1, wherein said second fan assembly comprises:
a first fan; and
a second fan positioned adjacent to said first fan, wherein said first fan is located over said fifth plurality of fins and said second fan is located over said sixth plurality of fins.

6. The electric machine according to claim 5, said second fan assembly further comprising:
a second plate located between said third and fourth fans, whereby said second plate mitigates airflow interference between said third and fourth fans.

7. The electric machine according to claim 5, wherein:
said first fan of said second fan assembly produces air flow between said fifth plurality of fins and said fourth plurality of fins; and
said second fan of said second fan assembly produces air flow between said sixth plurality of fins and said third plurality of fins.

8. The electric machine according to claim 1, further comprising:
a first mounting plate coupled with an outer edge of said third plurality of fins;
a second mounting plate coupled with an outer edge of said third plurality of fins, wherein said second mounting plate is located adjacent to said first mounting plate; and
wherein said first and second mounting plates are operable to couple a first terminal box with said housing and mitigate interference between said first terminal box and airflow through said third plurality of fins.

9. The electric machine according to claim 1, further comprising:
a third mounting plate coupled with an outer edge of said fourth plurality of fins;
a fourth mounting plate coupled with an outer edge of said fourth plurality of fins, wherein said fourth mounting plate is located adjacent to said third mounting plate; and
wherein said third and fourth mounting plates are operable to couple a second terminal box with said housing and mitigate interference between said second terminal box and airflow through said fourth plurality of fins.

10. The electric machine according to claim 1, wherein said third plurality of fins and said fourth plurality of fins comprise a greater height than said first, second, fifth and sixth pluralities of fins.

11. The electric machine according to claim 1, wherein said housing comprises a substantially cylindrical geometry, said third plurality of fins are located circumferentially adjacent to said second plurality of fins, said fourth plurality of fins are located circumferentially adjacent to said first plurality of fins, said fifth plurality of fins are located circumferentially adjacent to said fourth plurality of fins opposite said first plurality of fins, and said sixth plurality of fins are located circumferentially adjacent to said third plurality of fins opposite said second plurality of fins.

12. An electric machine, comprising:
a housing having a generally cylindrical geometry, wherein said housing defines a longitudinal axis;
a first plurality of fins coupled with a radially outer surface of said housing, wherein said first plurality of fins are positioned parallel to said longitudinal axis;
a second plurality of fins coupled with said radially outer surface of said housing positioned transverse to said longitudinal axis, wherein at least a portion of said second plurality of fins is located axially adjacent to said first plurality of fins;
a third plurality of fins coupled with said radially outer surface of said housing, wherein at least a portion of said third plurality of fins is located axially adjacent to said second plurality of fins and circumferentially adjacent to said first plurality of fins, wherein said third plurality of fins are positioned transverse to said longitudinal axis;
a fourth plurality of fins coupled with said radially outer surface of said housing, wherein at least a portion of said fourth plurality of fins is located axially adjacent to said third plurality of fins and circumferentially adjacent to said second plurality of fins, wherein said fourth plurality of fins are positioned parallel to said longitudinal axis;
a first fan assembly located at least partially above said first and second pluralities of fins; and
a second fan assembly located at least partially above said third and fourth pluralities of fins.

13. The electric machine according to claim 12, wherein each of said second plurality of fins comprises:
a first portion; and
a second portion located adjacent to said first portion, wherein said second portion comprises a greater height than said first portion.

14. The electric machine according to claim 13, wherein at least one of said second plurality of fins further comprises:
a third portion located adjacent to said second portion opposite said first portion, wherein said second portion comprises a greater height than said third portion.

15. The electric machine according to claim 12, wherein each of said third plurality of fins comprises:
a first portion; and
a second portion located adjacent to said first portion, wherein said second portion comprises a greater height than said first portion.

16. The electric machine according to claim 15, wherein at least one of said third plurality of fins further comprises:
a third portion located adjacent to said second portion opposite said first portion, wherein said second portion comprises a greater height than said third portion.

17. The electric machine according to claim 16, further comprising:
a fin located between said second and third pluralities of fins, said fin having:
a first portion;
a second portion adjacent to said first portion,
a third portion adjacent to said second portion opposite said first portion,
wherein said second portion comprises a greater height than said first and third portions, and
wherein said fin is positioned transverse to said longitudinal axis.

18. The electric machine according to claim 14, further comprising:
a first mounting plate coupled with an outer edge of said second portion of one or more of said second plurality of fins;
a second mounting plate coupled with an outer edge of said second portion of one or more of said second plurality of fins, wherein said second mounting plate is located adjacent to said first mounting plate; and
wherein said first and second mounting plates are operable to couple a first terminal box with said housing.

19. The electric machine according to claim 15, further comprising:
a third mounting plate coupled with an outer edge of said second portion of one or more of said third plurality of fins;
a fourth mounting plate coupled with an outer edge of said second portion of one or more of said third plurality of fins, wherein said fourth mounting plate is located adjacent to said third mounting plate; and
wherein said third and fourth mounting plates are operable to couple a second terminal box with said housing.

20. The electric machine according to claim 15, further comprising:
a fifth mounting plate coupled with an outer edge of said third portion of one or more of said second plurality of fins;
a sixth mounting plate coupled with an outer edge of said first portion of one or more of said third plurality of fins; and
wherein said fifth and sixth mounting plates are operable to at least partially couple said second fan assembly with said housing.

21. The electric machine according to claim 16, further comprising:
a seventh mounting plate coupled with an outer edge of said third portion of one or more of said third plurality of fins; and
an eighth mounting plate coupled with an outer edge of said first portion of one or more of said second plurality of fins;
wherein said seventh and eighth mounting plates are operable to at least partially couple said first fan assembly with said housing.
